(19) United States
(12) Patent Application Publication
(10) Pub. No.: US 2013/0100899 A1
(43) Pub. Date: Apr. 25, 2013

(54) MACHINE TYPE COMMUNICATION DEVICE, APPARATUS AND METHOD FOR ALLOCATING RESOURCES TO THE SAME, AND DATA TRANSMISSION/RECEPTION METHOD OF THE SAME

(71) Applicant: Electronics and Telecommunications Research Institute, Daejeon (KR)

(72) Inventors: Il Gyu KIM, Chungbuk (KR); Moon Sik LEE, Daejeon (KR); Young Seog SONG, Daejeon (KR); Jun Hwan LEE, Seoul (KR)

(73) Assignee: Electronics and Telecommunications Research Institute, Daejeon (KR)

(21) Appl. No.: 13/654,939

(22) Filed: Oct. 18, 2012

(30) Foreign Application Priority Data
Oct. 19, 2011 (KR) 10-2011-0106892
Jun. 8, 2012 (KR) 10-2012-0061199

(51) Int. Cl. H04W 72/04

(52) U.S. Cl. 370/329

(57) ABSTRACT

Provided are a machine type communication (MTC) device, an apparatus and method for allocating resources to the MTC device, and a data transmission/reception method of the MTC device. The method of allocating resources to at least one user equipment (UE) and the MTC device includes determining whether there are resources allocated for an MTC device in a resource section, and when there are resources allocated for an MTC device, determining the class of the MTC device, determining the bandwidth of a resource region for the MTC device, and configuring a downlink frame according to the bandwidth of the resource region for the MTC device.

### CLAIM FOR PRIORITY

This application claims priority to Korean Patent Application No. 10-2011-0106892 filed on Oct. 19, 2011 and Korean Patent Application No. 10-2012-0061199 filed on Jun. 8, 2012 in the Korean Intellectual Property Office (KIPO), the entire contents of which are hereby incorporated by reference.

### BACKGROUND

1. Technical Field

Example embodiments of the present invention relate in general to resource allocation for machine to machine (M2M) communication (or machine type communication (MTC)), and more particularly, to an MTC device, an apparatus and method for allocating resources to the MTC device, and a data transmission/reception method of the MTC device.

2. Related Art

Long Term Evolution (LTE)-based mobile communication systems are proliferating all over the world. As a cellular mobile communication system based on orthogonal frequency division multiplexing (OFDM), LTE systems (Third Generation Partnership Project (3GPP) Rel-8/Rel-9) support a scalable bandwidth such as 1.4 MHz, 3 MHz, 5 MHz, 10 MHz, 15 MHz and 20 MHz.

Such an LTE scheme is for general cellular phone or smart phone users, in which each base station should support only one of the scalable bandwidths according to frequency band assigned to a mobile communication provider, but user equipment (UE) should support any frequency bands in which a base station operates. In other words, UE should support a maximum bandwidth of 20 MHz.

Meanwhile, an LTE-Advanced (A) scheme (3GPP Rel-10) having evolved from the LTE scheme additionally introduces multi-carrier transmission in which each carrier occupies one bandwidth among 1.4 MHz, 3 MHz, 5 MHz, 10 MHz, 15 MHz and 20 MHz, and UE supporting Rel-10 standard may receive a plurality of carriers. LTE-A UE supporting 3GPP Rel-10 standard should also be able to receive at least a 20 MHz bandwidth, and simultaneously receive one or more carriers according to UE options. The LTE scheme has a maximum downlink transmission rate of 300 Mbps, and the LTE-A scheme can support up to 1 Gbps or more using multi-carrier aggregation. As described above, a modem for LTE UE or LTE-A UE that should support at least a 20 MHz bandwidth by default has very high power consumption. Thus, the modem supports relatively low-speed data, and is inappropriate for MTC UE that should be used for a maximum of several years with one battery charge.

Such a modem for cellular phone or smart phone UE should support at least a 20 MHz bandwidth and drastically increases power consumption of the UE. Thus, the modem is inappropriate for M2M or MTC UE that requires relatively low power and low-speed data.

According to service type, an MTC device can obtain a desired data transmission rate using a very small bandwidth (e.g., 1.4 MHz) or a medium bandwidth (e.g., 5 MHz).

While an MTC device can support a very low data transmission rate for several years after a battery is installed only once in the device, an MTC device can support a relatively high data transmission rate for a relatively short time.

However, all factors that a base station conventionally takes into consideration for resource allocation to UE are focused on normal UE, thus having too many problems to support MTC devices which have different characteristics than UE.

### SUMMARY

Accordingly, example embodiments of the present invention are provided to substantially obviate one or more problems due to limitations and disadvantages of the related art.

Example embodiments of the present invention provide a resource allocation method for a multi-bandwidth machine type communication (MTC) device that supports scalable bandwidths.

Example embodiments of the present invention provide a data transmission/reception method for an MTC device.

Example embodiments of the present invention provide an apparatus for allocating resources to a multi-bandwidth MTC device that supports a scalable bandwidth.

Example embodiments of the present invention provide an MTC device that operates with low power.

In some example embodiments, a resource allocation method includes: determining whether there are resources allocated for an MTC device in a resource section; when there are resources allocated for an MTC device, determining the class of an MTC device, and determining the bandwidth of a resource region for the MTC device; and configuring a downlink frame according to the bandwidth of the resource region for the MTC device.

Here, the resource region for the MTC device may include an MTC device control region and an MTC device data region.

The MTC device control region may include information about a position of the MTC device data region in the resource region.

Radio resources in the resource region for the MTC device may be allocated to the MTC device and also for data transmission to user equipment (UE).

According to an example embodiment of the present invention, the MTC control region may be located after a control region for UE on a time axis.

The resource allocation method may further include receiving bandwidth class information from at least one MTC device.

The resource region for the MTC device may be at the center of a bandwidth for UE on a frequency axis.

The control region for the MTC device may include at least one of system information and paging information about the MTC device.

In other example embodiments, a data transmission/reception method of an MTC device includes: receiving a downlink frame from a base station; decoding the received downlink frame in units of a resource section, and determining whether there is a resource region for an MTC device in the corresponding resource section; and extracting MTC device control information from a resource region for an MTC device, and obtaining a position of MTC device data from the extracted MTC device control information.

Decoding the received downlink frame in units of a resource section and determining whether there is a resource region for an MTC device in the corresponding resource section may include: performing blind decoding on a position of an MTC device control region available on a time axis; finding the number of symbols occupied by a control channel for UE through the decoding; and obtaining an MTC resource region present behind at least one symbol occupied by the control channel for the UE.

The data transmission/reception method of the MTC device may further include transmitting, at the MTC device, bandwidth class information about the MTC device to the base station.

Transmitting, at the MTC device, the bandwidth class information about the MTC device to the base station may include transmitting, at the MTC device, the bandwidth class information to the base station through a random access procedure or an uplink control channel.

In other example embodiments, a resource allocation apparatus includes: a frame configurator configured to determine whether there are resources allocated for an MTC device in a resource section, and when there are resources allocated for an MTC device, determine the class of the MTC device, determine the bandwidth of a resource region for the MTC device, and configure a downlink frame according to the bandwidth of the resource region for the MTC device; and a transceiver configured to transmit the configured downlink frame.

The resource allocation apparatus may further include a bandwidth information storage configured to store bandwidth class information received from at least one MTC device.

In other example embodiments, an MTC device includes: a receiver configured to receive a downlink frame from a base station; a controller configured to decode the downlink frame in units of a resource section, determine whether there is a resource region for an MTC device in the corresponding resource section, extract MTC device control information from a resource region for an MTC device, and obtain a position of MTC device data from the extracted MTC device control information; and a transmitter configured to transmit bandwidth class information about the MTC device to the base station.

The controller may perform blind decoding on a position of an MTC device control region available on a time axis, find the number of symbols occupied by a control channel for UE through the decoding, and obtain an MTC resource region present behind at least one symbol occupied by the control channel for the UE.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of a wireless communication network that provides a machine type communication (MTC) service to which example embodiments of the present invention are applied;

FIG. 2 is a conceptual diagram of various bandwidths supported by Long Term Evolution (LTE) communication systems;

FIG. 3 is a diagram showing relationship between bandwidth classes of a plurality of MTC devices having different bandwidths in use and a bandwidth supported by a base station according to an example embodiment of the present invention;

FIG. 4 is a diagram showing relationship between various MTC device bandwidth classes and a position of system information transmitted by a base station according to an example embodiment of the present invention;

FIG. 5 is a diagram showing relationship between various MTC device bandwidth classes and a position of system information transmitted by a base station according to another example embodiment of the present invention;

FIG. 6 shows an example embodiment of a frame structure of a mobile communication system to which the present invention is applied;

FIG. 7 to FIG. 9 show several frame structures including a resource region for an MTC device according to example embodiments of the present invention;

FIG. 10 is a block diagram of a base station according to an example embodiment of the present invention;

FIG. 11 is a block diagram of an MTC device according to an example embodiment of the present invention;

FIG. 12 is an operation flowchart illustrating a resource allocation method according to an example embodiment of the present invention; and

FIG. 13 is an operation flowchart illustrating a data transmission/reception method of an MTC device according to an example embodiment of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

It should also be noted that in some alternative implementations, operations may be performed out of the sequences depicted in the flowcharts. For example, two operations shown in the drawings to be performed in succession may in fact be executed substantially concurrently or even in reverse of the order shown, depending upon the functionality/acts involved.

The term “base station” used herein generally denotes a fixed point communicating with user equipment (UE), and may be referred to as a Node-B, evolved Node-B (eNB), base transceiver system (BTS), access point, and other terms.

The term “UE” used herein may be referred to as a mobile station (MS), user terminal (UT), wireless terminal, access terminal (AT), terminal, subscriber unit, subscriber station (SS), wireless device, wireless communication device, wireless transmit/receive unit (WTRU), mobile node, mobile, or other terms. Various example embodiments of UE may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or UE having a combination of such functions, but are not limited to these.

Meanwhile, to distinguish between UE that is frequently used by users and UE that is used for a machine type communication (MTC) service, the UE used for an MTC service will be referred to as an “MTC device,” and the UE used for general and conventional communication between users other than MTC will be referred to as UE.

Hereinafter, example embodiments of the present invention will be described in detail with reference to the appended drawings. To facilitate overall understanding of the present invention, like numbers refer to like elements throughout the description of the drawings, and the description of the same component will not be reiterated.

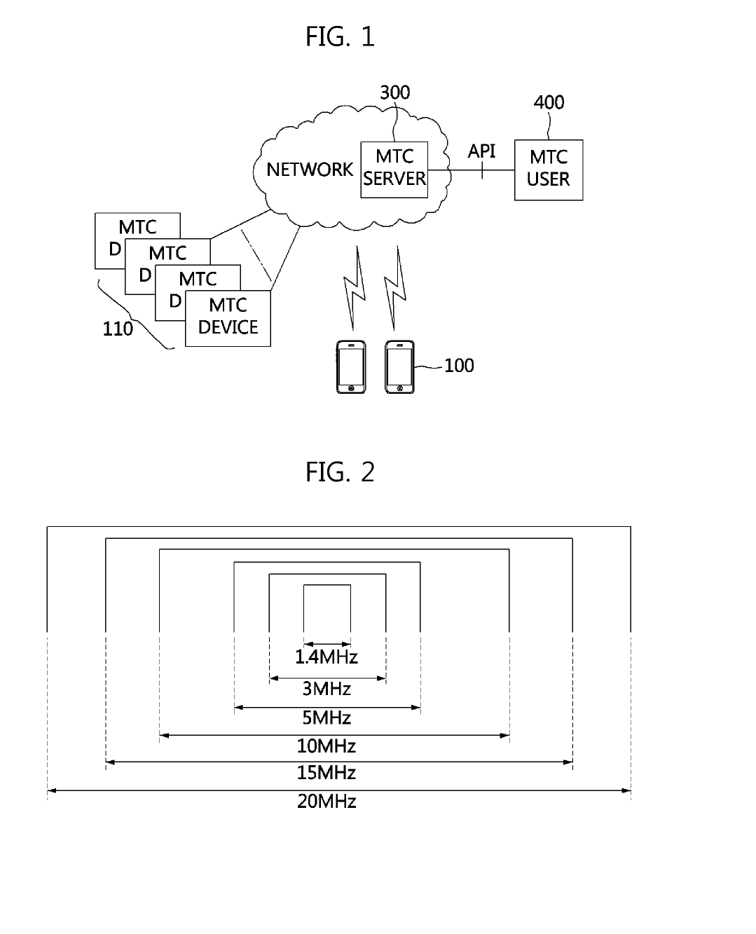

FIG. 1 is a conceptual diagram of a wireless communication network that provides an MTC service to which example embodiments of the present invention are applied.

As shown in FIG. 1, a wireless communication network that provides an MTC service includes an MTC server 300 for providing the MTC service, MTC devices 110, an MTC user 400, etc. in addition to an existing wireless communication network.

The MTC devices 110 are UE having an MTC function of communicating with the MTC server 300 and other MTC devices via a public land mobile network (PLMN).

The MTC server 300 communicates with the PLMN and communicates with the MTC devices 110 via the PLMN. Also, the MTC server 300 has an interface that can be accessed by the MTC user 400, and provides service for the MTC user 400. The MTC user 400 uses the service provided by the MTC server 300.

In the constitution of FIG. 1, the MTC server 300 is controlled by a network operator, who provides the MTC server 300 with an application programming interface (API), and the MTC user 400 accesses the MTC server 300 of the network operator through the API. Meanwhile, although FIG. 1 shows that the MTC server 300 is included in a network operator domain, the MTC server 300 may be present not in the network operator domain but outside the network operator domain. In this case, the MTC server 300 is not controlled by the network operator.

The MTC devices 110 communicate with the MTC server 300 present in the network through a base station (not shown).

To provide an MTC service through the MTC devices 400 and the mobile communication system shown in FIG. 1, smooth interoperation is required through wireless connection between the MTC devices 400 and the mobile communication system. Thus, it is necessary to examine characteristics, particularly, bandwidth characteristics of the mobile communication system that interoperates with the MTC devices 400.

FIG. 2 is a conceptual diagram of various bandwidths supported by Long Term Evolution (LTE) communication systems.

An LTE system (Third Generation Partnership Project (3GPP) Rel-8/Rel-9) is a cellular mobile communication system based on orthogonal frequency division multiplexing (OFDM), and designed to be constructed according to necessity regardless of the time and position at which frequency resources become available. Thus, an LTE wireless connection can operate in a wide range of frequency bands from 450 MHz to at least 3.5 GHz.

The LTE system needs to be able to establish a LTE wireless connection in different frequency bands and also supports various transmission bandwidths according to standards, thereby operating at a variety of assigned frequencies. To efficiently provide a very high data rate when frequency resources are available, broadband transmission is needed. However, a sufficiently high frequency is not always available due to limitations of a frequency band to be used or gradual frequency conversion from another wireless connection technology. In this case, the LTE system may operate in a smaller bandwidth.

In other words, physical layer standards of LTE have no relation to bandwidths, and there is no specific assumption of a transmission bandwidth supporting the smallest value or more. In practice, LTE wireless connection supports a scalable bandwidth as shown in FIG. 2. In other words, the LTE system does not support one determined frequency bandwidth but supports several bandwidths such as 1.4 MHz, 3 MHz, 5 MHz, 10 MHz, 15 MHz and 20 MHz.

In a mobile communication system to which example embodiments of the present invention are applied, one or more carriers are present for UE (e.g., a smart phone, or a cellular phone) in a downlink, and one of the bandwidths shown in FIG. 2 is used for each carrier. The UE is characterized by supporting a maximum bandwidth (e.g., 20 MHz in FIG. 2) that at least one carrier can have.

On one of one or more carriers, a downlink signal for an MTC device is transmitted from a base station, and MTC devices according to example embodiments of the present invention are classified into classes according to bandwidths supportable by the respective devices. For example, when MTC devices support 1.4 MHz bandwidth, 3 MHz bandwidth and 5 MHz bandwidth, the MTC devices may be classified into class A, class B and class C according to bandwidths supportable by the respective devices.

The reason that bandwidth classes for MTC devices are defined in the present invention as described above is that, when different data transmission rates are required according to service types, it is most efficient for each MTC device to transmit/receive only a minimum bandwidth appropriate for the MTC device itself in terms of power consumption.

In the present invention, a situation in which a plurality of MTC devices classified into several bandwidth classes as described above coexist is taken into consideration. For example, assuming that respective bandwidth types are bandwidth (BW) class A, BW class B and BW class C, there can be several example embodiments.

As a first example embodiment, there can be a case in which MTC devices in a mobile communication system are classified into two bandwidth classes. For example, MTC devices corresponding to BW class A support 1.4 MHz bandwidth, and MTC devices corresponding to BW class B support bandwidths up to 5 MHz (i.e., 1.4 MHz, 3 MHz and 5 MHz all).

As a second example embodiment, there can be a case in which MTC devices in a mobile communication system are classified into three bandwidth classes, that is, BW class A, BW class B and BW class C. For example, MTC devices corresponding to BW class A only support up to 1.4 MHz bandwidth, MTC devices corresponding to BW class B support bandwidths up to 3 MHz (i.e., 1.4 MHz and 3 MHz both), and MTC devices corresponding to BW class C support bandwidths up to 5 MHz (i.e., 1.4 MHz, 3 MHz and 5 MHz all).

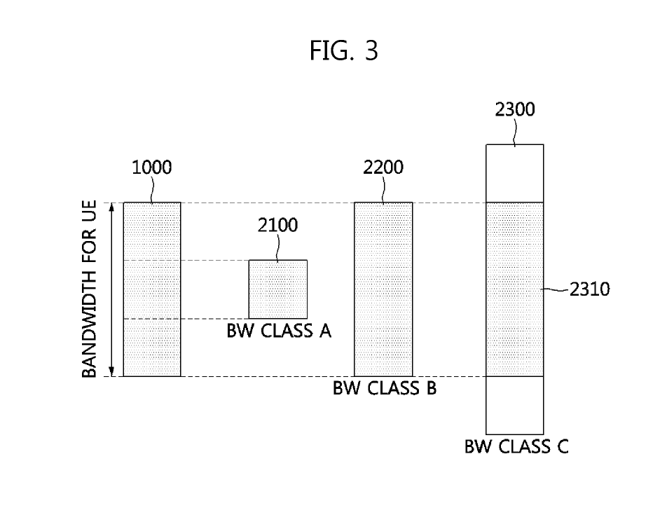

FIG. 3 is a diagram showing relationship between bandwidth classes of a plurality of MTC devices having different bandwidths in use and a bandwidth supported by a base station according to an example embodiment of the present invention.

In FIG. 3, it is assumed that a bandwidth allocated to a base station for UE is 5 MHz, and MTC devices in a mobile communication system are classified into three bandwidth classes (1.4 MHz, 3 MHz and 5 MHz bandwidth classes).

A base station transmits signals for UEs (e.g., cellular phones and smart phones) as well as MTC devices. Here, when a bandwidth 1000 (one of the scalable bandwidths shown in FIG. 2) of a signal transmitted by the base station is greater than a bandwidth supportable by an MTC device according to an example embodiment of the present invention, the base station includes a data signal for the MTC device in only the bandwidth supportable by the MTC device, and transmits the data signal.

For example, in FIG. 3, the bandwidth 1000 supported by the base station is greater than a bandwidth 2100 of class A. In this case, the base station does not use the entire supportable bandwidth but uses the bandwidth 2100 of class A to transmit data. An MTC device selectively receives only a signal corresponding to the bandwidth allocated to the MTC device itself within the entire bandwidth transmitted by the base station, and demodulates the received signal.

When the bandwidth 1000 of a signal transmitted for UE by the base station system according to example embodiments of the present invention is the same as a bandwidth supported by an MTC device, that is, in the case of an MTC device that supports a bandwidth 2200 of class B in FIG. 3, the base station transmits a data signal for the MTC device in the bandwidth of the base station itself, and the MTC device demodulates the signal in the bandwidth 2200 transmitted by the base station.

When the bandwidth 1000 of a signal transmitted for UE by the base station system according to example embodiments of the present invention is smaller than a bandwidth 2300 supported by an MTC device according to example embodiments of the present invention, the base station transmits a data signal for the MTC device in the entire bandwidth currently transmitted by the base station within the bandwidth 2300 supported by the MTC device, and the MTC device demodulates the signal in only a bandwidth 2310 transmitted by the base station within the bandwidth 2300 that can be received by the MTC device itself.

An MTC device according to example embodiments of the present invention may notify a base station of its bandwidth class information through a random access procedure or an uplink control channel upon initial network access or call setup.

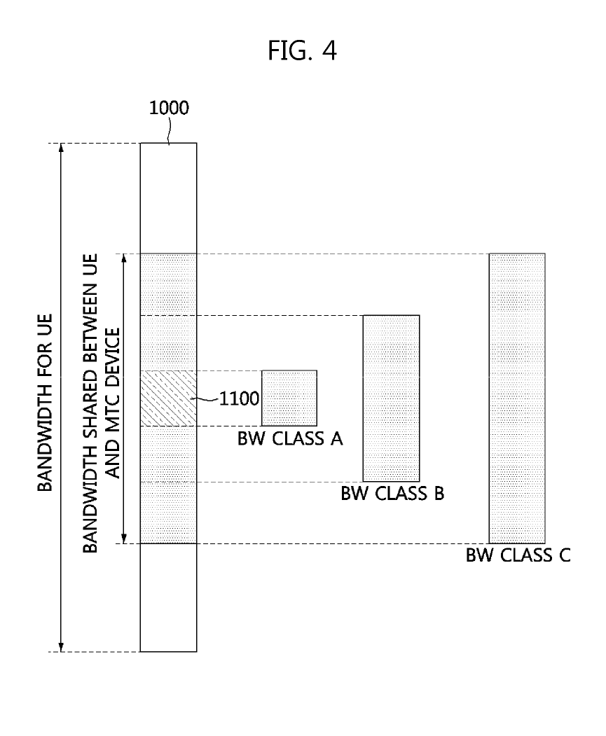

FIG. 4 is a diagram showing relationship between various MTC device bandwidth classes and a position of system information transmitted by a base station according to an example embodiment of the present invention.

FIG. 4 is based on the same assumption as FIG. 3 except that the bandwidth allocated to a base station for UE is 10 MHz. The same assumption is that MTC devices present in a system have three bandwidth classes of 1.4 MHz, 3 MHz and 5 MHz.

A base station according to example embodiments of the present invention transmits initial system information, etc. for an MTC device in a portion corresponding to the minimum bandwidth of a scalable bandwidth including the center of a bandwidth occupied by the corresponding carrier. Here, the initial system information includes, for example, information about a bandwidth of a carrier for current UE and information about the bandwidth allocated for an MTC device, or the information about the bandwidth allocated for an MTC device.

Upon obtainment of initial system information, an MTC device having various bandwidth classes first obtains system information transmitted by the base station by searching only the minimum bandwidth. In the example embodiment of FIG. 4, system information is transmitted in 1.4 MHz bandwidth 1100 at the center of a bandwidth transmitted by the base station.

According to an example embodiment of the present invention, a transmission band for an MTC device is present at the center of a carrier bandwidth 1000 transmitted for UE as shown in FIG. 4.

Although example embodiments in which several bandwidth classes are defined for an MTC device in a system have been illustrated in FIG. 3 and FIG. 4, a case in which only one bandwidth class is defined is also within the scope of the present invention.

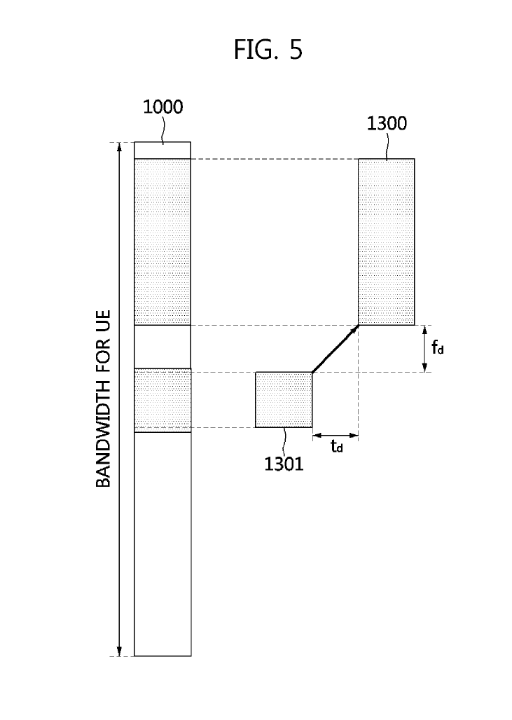

FIG. 5 is a diagram showing relationship between various MTC device bandwidth classes and a position of system information transmitted by a base station according to another example embodiment of the present invention.

In the example embodiment shown in FIG. 5, when a carrier bandwidth 1000 transmitted for UE by a base station is greater than an MTC device bandwidth having a bandwidth class, the base station may assign a data channel 1300 for an MTC device to a band other than the center of a bandwidth supported by the base station itself.

In this case, the base station may separately prepare a common control region 1301 at the center of the bandwidth supported by the base station itself, include band information about the data channel 1300 for an MTC device (e.g., band information with respect to the common control region 1301 as f_{d} of FIG. 5), and timing information (e.g., timing information with respect to the common control region 1301 as t_{d} of FIG. 5), or one of the band information and the timing information in the common control region 1301 as shown in FIG. 5, and transmit the information to an MTC device. In the common control region 1301, paging information for the MTC device as well as the system information may be included.

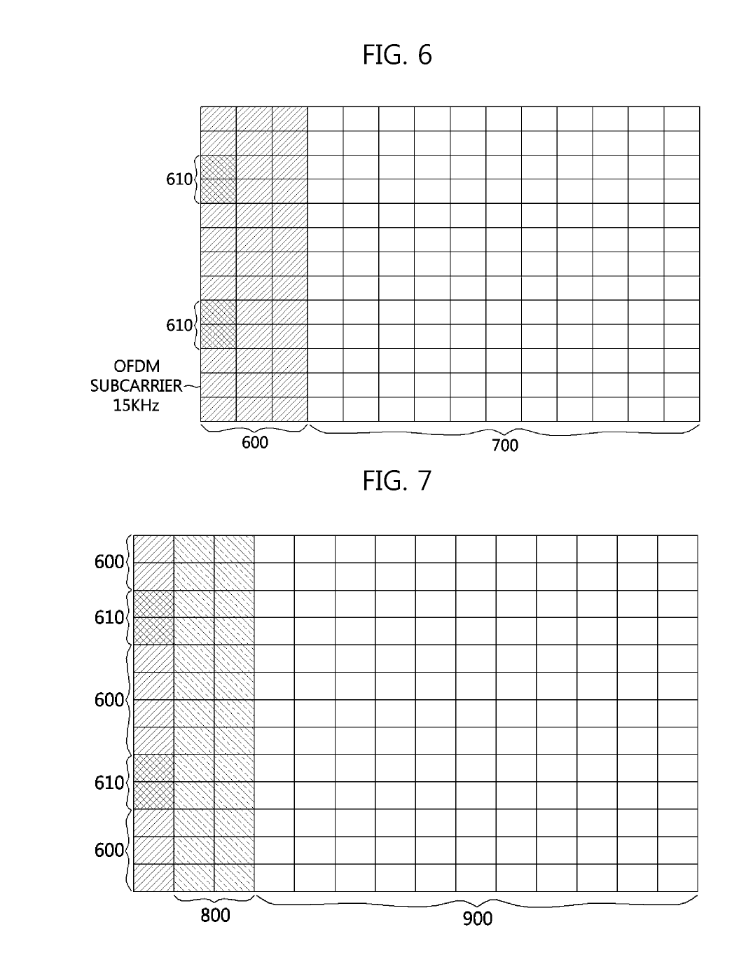

FIG. 6 shows an example embodiment of a frame structure of a mobile communication system to which the present invention is applied.

In mobile communication systems conforming to 3GPP LTE standards (Rel-8 and Rel-9) and LTE Advanced standard (Rel-10), an orthogonal frequency division multiple access (OFDMA) scheme is used for a downlink. In a 3GPP LTE system, one frame has a duration of 10 msec and consists of 10 subframes.

The length of one subframe is 1 msec, and when a normal cyclic prefix (CP) is used as shown in FIG. 6, each subframe has 14 OFDM symbols. One subframe may include a downlink control channel (physical downlink control channel (PDCCH)) region 600 and a data channel (physical downlink shared channel (PDSCH)) region 700.

The length of the control channel region 600 consists of one to three symbols according to system load, and is variable according to frames. A base station sets the position of a physical control format indicator channel (PCFICH) 610 that carries length information about the control channel region 600 as a first symbol of a subframe, and transmits the first subframe.

Normal LTE/LTE-A UE receiving the symbol may become aware of the number of symbols in the control channel region 600 by demodulating the PCFICH 610. Naturally, the UE becomes aware of a start point of the data channel (PDSCH) (a fourth symbol in FIG. 6), and thus channel demodulation is enabled.

For UE, the aforementioned PCFICH 610 is spread over an entire carrier bandwidth and transmitted, which is intended to obtain frequency diversity. In LTE standards (Rel-8 and Rel-9) and LTE Advanced standard (Rel-10), a synchronization channel (SCH), a physical broadcast channel (PBCH), a reference signal, etc. (not shown for convenience) are defined in addition to the aforementioned channels.

Meanwhile, example embodiments of the present invention are based on compatibility with Rel-8/Rel-9 LTE UE and Rel-10 LTE-A UE. Thus, the existing control channel region 600 remains as is, and a control channel for an MTC device is prepared in the data channel region 700.

A control channel for an MTC device according to example embodiments of the present invention may include a broadcasting channel for an MTC device, a common control channel for an MTC device, or the MTC device common control channel, MTC device-specific control channels, etc.

FIG. 7 to FIG. 9 show several frame structures including a resource region for an MTC device according to example embodiments of the present invention.

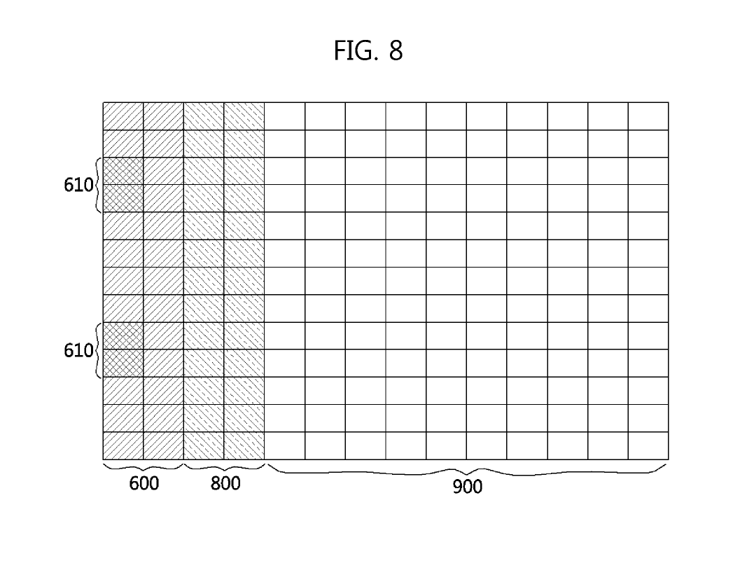

FIG. 7 shows an example embodiment in which a control channel for normal UE includes only one symbol, FIG. 8 shows an example embodiment in which a control channel for normal UE includes two symbols, and FIG. 9 shows an example embodiment in which a control channel for normal UE includes three symbols.

In example embodiments of the present invention, the position of a transmission symbol of a control channel (or broadcasting channel) for an MTC device is set differently according to the length of a control channel for UE. Thus, a base station can implicitly notify UE of length information about a control channel for the UE.

An MTC device according to an example embodiment of the present invention performs demodulation and decoding on each of three different control channel positions (FIG. 7 to FIG. 9), determines a position at which no decoding error occurs as a correct position, and demodulates a data channel for an MTC device on the basis of the corresponding position. In other words, an MTC device performs blind decoding to know the number of symbols occupied by a control channel for UE.

In the example embodiments of FIG. 7 to FIG. 9, an MTC device can be aware of the number of symbols occupied by a control channel for UE by performing blind decoding of an MTC device control channel symbol position available on the time axis. However, in another example embodiment of the present invention, a start point of a subcarrier symbol for a control channel may be differently set not on the time axis but on the frequency axis.

Meanwhile, in LTE/LTE-A standards, a data channel is assigned in frequency/time resource block units. Here, one subframe (14 symbols) and 12 subcarriers are referred to as one resource block (RB), and radio resources are allocated in RB units. When UE has high data transmission rate, several RBs may be used in one subframe. For example, 24 or 48 subcarriers may be used.

In example embodiments of the present invention, when OFDMA frequency/time resource regions in a bandwidth 800 and 900 shared between normal UE and an MTC device are not allocated to the MTC device, the resource region 800 of FIG. 7 to FIG. 9 may be allocated to the normal UE. Also in this case, the MTC device can attempt blind decoding of a control channel designated for an MTC device. However, there is no control channel designated for an MTC device, and cyclic redundancy check (CRC) errors occur as all decoding results. On the basis of the decoding results, the MTC device can determine that there is no data of the MTC device at a current resource position.

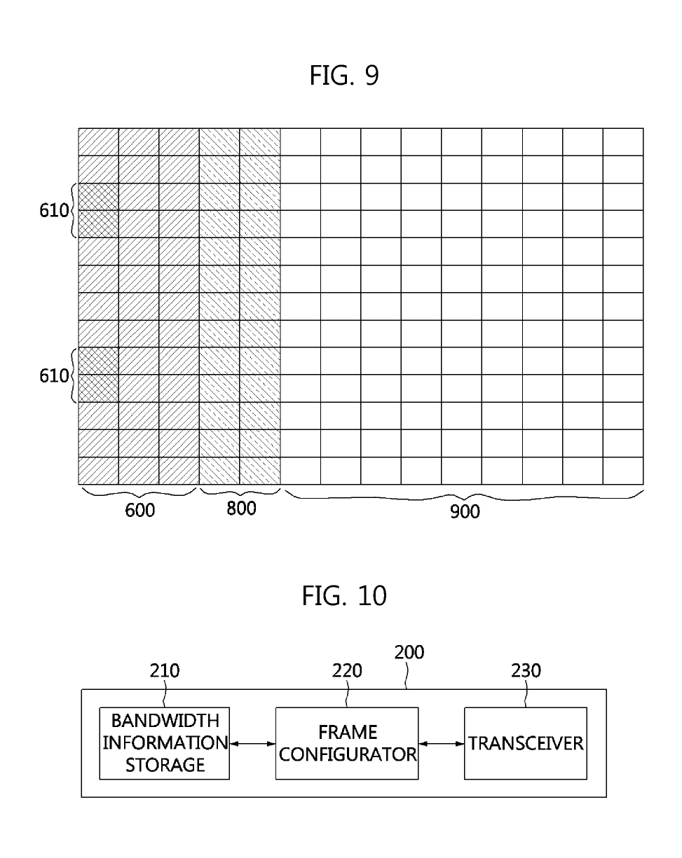

FIG. 10 is a block diagram of a base station according to an example embodiment of the present invention.

A base station 200 according to example embodiments of the present invention may include a bandwidth information storage 210, a frame configurator 220, and a transceiver 230.

The bandwidth information storage 210 stores bandwidth class information received from at least one MTC device. For example, identifiers of MTC devices may be stored in the form of a table according to several bandwidth classes to which the MTC devices belong.

The frame configurator 220 determines whether there are resources allocated for an MTC device in a resource section, for example, one subframe. When there are resources allocated for an MTC device, the frame configurator 220 determines the class of the MTC device, determines the bandwidth of a resource region for the MTC device, and configures a downlink frame according to the bandwidth of the resource region for the MTC device.

The transceiver 230 transmits the downlink frame configured by the frame configurator 220 to at least one MTC device.

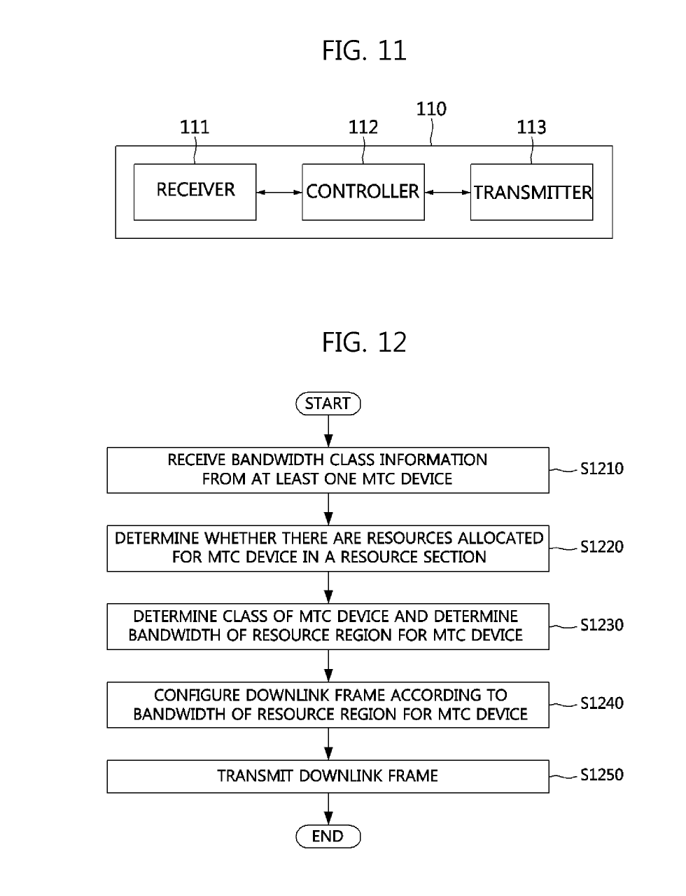

FIG. 11 is a block diagram of an MTC device according to an example embodiment of the present invention.

An MTC device 110 according to example embodiments of the present invention may include a receiver 111, a controller 112, and a transmitter 113.

First, the receiver 111 receives a downlink frame from a base station. The controller 112 decodes the received frame in units of a resource section, determines whether there is a resource region for an MTC device in the corresponding resource section, and extracts MTC device control information from a resource region for an MTC device, and obtains the position of MTC device data from the extracted MTC device control information.

The transmitter 113 transmits bandwidth class information about the MTC device to the base station.

FIG. 12 is an operation flowchart illustrating a resource allocation method according to an example embodiment of the present invention.

The resource allocation method illustrated in FIG. 12 is mainly performed by a base station, and this example embodiment will be described centering on a base station.

A base station receives bandwidth class information from at least one MTC device (S1210). This step can occur at any point in time between step 1220 and step 1250 described below. In FIG. 12, step 1210 is illustrated first for convenience.

To configure a downlink frame, the base station determines whether there are resources allocated for an MTC device in a resource section (S1220). When there are resources allocated for an MTC device, the base station determines the class of an MTC device, and determines the bandwidth of a resource region for the MTC device (S1230). Subsequently, the base station configures a downlink frame according to the bandwidth of the resource region for the MTC device (S1240). Finally, the base station transmits the configured downlink frame (S1250).

Here, the resource region for the MTC device may include an MTC device control region and an MTC device data region.

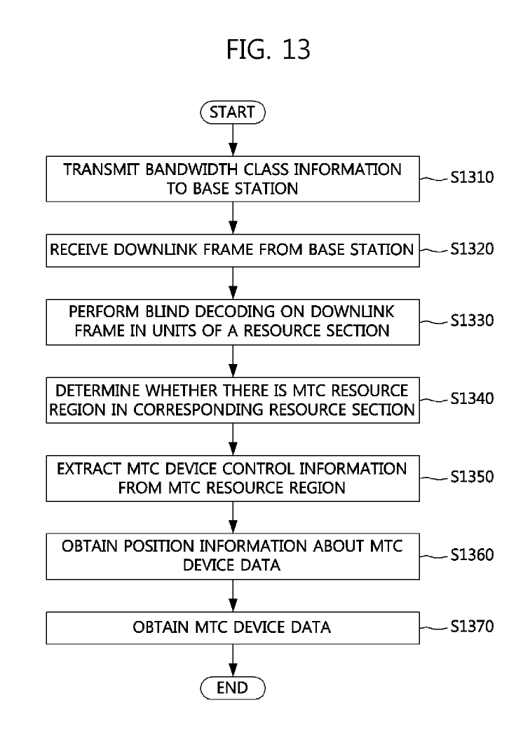

FIG. 13 is an operation flowchart illustrating a data transmission/reception method of an MTC device according to an example embodiment of the present invention.

An MTC device according to example embodiments of the present invention transmits bandwidth class information to a base station (S1310), thereby notifying the base station of information about the bandwidth supported by the MTC device itself.

Subsequently, the MTC device receives a downlink frame from the base station (S1320), decodes the received downlink frame in units of a resource section (S1330), and determines whether there is a resource region for an MTC device in the corresponding resource section (S1340).

Here, decoding performed by the MTC device is blind decoding of a position of an MTC device control region available on the time axis. Through such blind decoding, the MTC device finds the number of symbols occupied by a control channel for UE, and obtains an MTC resource region located after at least one symbol occupied by the control channel for the UE, thereby determining whether there is a resource region for an MTC device in the corresponding resource section.

Subsequently, the MTC device extracts MTC device control information from the resource region for an MTC device (S1350), obtains position information about MTC device data from the extracted MTC device control information (S1360), and finally obtains the MTC device data (S1370).

According to the above-described example embodiments of the present invention, it is possible to provide transmission technology for MTC devices that support low-speed data while maintaining compatibility with UE conforming to existing LTE standard (Rel-8/Rel-9) and LTE-A standard (Rel-10).

Thus, the example embodiments of the present invention enable service for MTC UE that can be used for a maximum of several years with one battery charge using an LTE/LTE-A-based mobile communication network.

Also, in the example embodiments of the present invention, MTC device UE classes are classified according to service types, and an MTC service is provided according to the classified MTC device UE classes, such that various MTC device types can be supported.

While the example embodiments of the present invention and their advantages have been described in detail, it should be understood that various changes, substitutions and alterations may be made herein without departing from the scope of the invention.

What is claimed is:

1. A method of allocating resources to at least one user equipment (UE) and machine type communication (MTC) device, comprising:
determining whether there are resources allocated for an MTC device in a resource section;
when there are resources allocated for an MTC device, determining a class of the MTC device and determining a bandwidth of a resource region for the MTC device; and
configuring a downlink frame according to the bandwidth of the resource region for the MTC device.

2. The method of claim 1, wherein the resource region for the MTC device includes an MTC device control region and an MTC device data region.

3. The method of claim 2, wherein the MTC device control region includes information about a position of the MTC device data region in the resource region.

4. The method of claim 1, wherein radio resources in the resource region for the MTC device is allocated to UEs as well as the MTC device.

5. The method of claim 2, wherein the MTC control region is located after a control region for UE on a time axis.

6. The method of claim 1, further comprising receiving bandwidth class information from the at least one MTC device.

7. The method of claim 1, wherein the resource region for the MTC device is located at a center of a bandwidth for UE on a frequency axis.

8. The method of claim 2, wherein the MTC device control region includes at least one of system information and paging information about the MTC device.

9. A data transmission/reception method of a machine type communication (MTC) device, comprising:
receiving a downlink frame from a base station;
decoding the received downlink frame in units of a resource section and determining whether there is a resource region for an MTC device in the corresponding resource section; and
extracting MTC device control information from a resource region for an MTC device, and obtaining a position of MTC device data from the extracted MTC device control information.

10. The data transmission/reception method of claim 9, wherein decoding the received downlink frame in units of a resource section and determining whether there is a resource region for an MTC device in the corresponding resource section includes:
performing blind decoding on a position of an MTC device control region available on a time axis;
finding a number of symbols occupied by a control channel for user equipment (UE) through the decoding; and
obtaining an MTC resource region located after at least one symbol occupied by the control channel for the UE.

11. The data transmission/reception method of claim 9, further comprising transmitting bandwidth class information about the MTC device to the base station.

12. The data transmission/reception method of claim 11, wherein transmitting the bandwidth class information about the MTC device to the base station includes transmitting the bandwidth class information to the base station through a random access procedure or an uplink control channel.

13. The data transmission/reception method of claim 9, wherein the resource region for an MTC device is located at a center of a bandwidth for UE on a frequency axis.

14. A resource allocation apparatus, comprising:
a frame configurator configured to determine whether there are resources allocated for a machine type communication (MTC) device in a resource section, and when there are resources allocated for the MTC device, determine a class of the MTC device, determine a bandwidth of a resource region for the MTC device, and configure a downlink frame according to the bandwidth of the resource region for the MTC device; and
a transceiver configured to transmit the configured downlink frame.

15. The resource allocation apparatus of claim 14, further comprising a bandwidth information storage configured to store bandwidth class information received from at least one MTC device.

16. A machine type communication (MTC) device, comprising:
a receiver configured to receive a downlink frame from a base station;
a controller configured to decode the downlink frame in units of a resource section, determine whether there is a resource region for an MTC device in the corresponding resource section, extract MTC device control information from a resource region for an MTC device, and obtain a position of MTC device data from the extracted MTC device control information; and
a transmitter configured to transmit bandwidth class information about the MTC device to the base station.
